(19) United States
(12) Patent Application Publication
(10) Pub. No.: US 2010/0285888 A1
(43) Pub. Date: Nov. 11, 2010

(54) MIXING IMPELLER HUB APPARATUS AND METHOD

(75) Inventors: Daniel Phillip Newton LEE, Cheshire (GB); Matthew J. Lunt, Cheshire (GB)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation, Charlotte, NC (US)

(21) Appl. No.: 12/435,643

(22) Filed: May 5, 2009

(51) Int. Cl. F16D 7/02

(52) U.S. Cl. 464/41

(57) ABSTRACT

An impeller mounting apparatus and method have an elongated cylindrical shaft, a hub having a central aperture therethrough larger than the outer diameter of the shaft, with at least one first channel disposed on an inner circumference of the hub, having an end opening with a first diameter larger than the shaft, and at least one first elastomeric ring having a central circumference less than the outer circumference of the shaft, and adapted to fit over the shaft and inside the channel, thereby becoming outwardly expanded into the channel, the elastomeric ring further having a first ear that projects along the shaft adjacent the end opening, wherein the first ear is dimensioned so that upon expansion the ear does not completely fill the end opening.

### FIELD OF THE INVENTION

The invention relates generally to the field of mixing apparatuses, in which a rotating shaft drives radially extending impellers, to mix a solution or other liquid which is contained inside a vessel. More particularly, some embodiments of the invention relate to attachment apparatuses and methods for mounting an impeller hub on to a shaft.

### BACKGROUND OF THE INVENTION

Mixing devices are in wide use in industry. In some mixing devices, a container or vessel is provided in order to hold a solution, liquid or other material to be mixed or agitated. A shaft, typically vertical but sometimes horizontal, extends into the material to be mixed and is rotatably driven, sometimes by a motor disposed at one end of the shaft outside of the vessel. Along its axial length, the impeller shaft typically supports, directly or indirectly, one or more sets of radially extending mixing impellers. In some instances, the impellers are welded directly on to the shaft. However, in other applications, it is desirable to provide adjustment of the axial position of the impellers, or even a switch out of the impellers, either between uses of the mixer, depending on the material being mixed, or simply at initial setup or installation.

For those situations, it has been known to provide impellers that are fixedly mounted to a hub, with the hub being detachably mounted to the shaft. Such arrangements have been known to use key ways or set screws in order to rotationally and axially fix the location of the hub on to the shaft. These systems have generally been satisfactory, but in some instances it would be desirable to reduce the number of parts, and also to reduce metal-to-metal contact keys and set screws with the shaft. In some highly sanitary environments, it may also be desirable to reduce the number of locations where germs or particulates may become entrained, such as might occur in some instances with key ways or set screws. The terms liquid solution and material to be mixed are used interchangeably; also, the terms missing, agitation and aeration are used interchangeably.

Accordingly, there is a need in the art for improved impeller hub assemblies and methods which can reduce the number of component parts involved, be easy to install, and avoid the need for key ways and/or set screws.

### SUMMARY OF THE INVENTION

Some embodiments of the invention provide improved impeller hub assemblies and methods which can reduce the number of component parts involved, be easy to install, and avoid the need for key ways and/or set screws.

An embodiment of the present invention provides an impeller mounting apparatus, with an elongated cylindrical shaft, a hub having a central aperture therethrough larger than the outer diameter of the shaft, at least one first channel disposed on an inner circumference of the hub, having an end opening with a first diameter larger than the shaft, and at least one first elastomeric ring having a central circumference less than the outer circumference of the shaft, and adapted to fit over the shaft and inside the channel, thereby becoming outwardly expanded into the channel, the elastomeric ring further having a first ear that projects along the shaft adjacent the end opening, wherein the first ear is dimensioned so that upon expansion the ear does not completely fill the end opening.

A second embodiment provides an impeller mounting apparatus which includes an elongated cylindrical shaft, impeller mounting means having a central aperture therethrough larger than the outer diameter of the shaft, at least one first channel disposed on an inner circumference of the impeller mounting means, having an end opening with a first diameter larger than the shaft, and at least one first elastomeric ring having a central circumference less than the outer circumference of the shaft, and adapted to fit over the shaft and inside the channel. The end opening becomes outwardly expanded into the channel, and the elastomeric ring has a first ear that projects along the shaft adjacent the end opening. The first ear is dimensioned so that upon expansion the ear does not completely fill the end opening, wherein the first ear is dimensioned so that upon expansion the ear does not completely fill the end opening.

Another embodiment provides a method for mounting an impeller into an elongated cylindrical shaft and providing a hub having a central aperture therethrough larger than the outer diameter of the shaft and at least one first channel disposed on an inner circumference of the hub, having an end opening with a first diameter larger than the shaft. At least one first elastomeric ring has a central circumference less than the outer circumference of the shaft, and is adapted to fit over the shaft and inside the channel, thereby becoming outwardly expanded into the channel. Further, the elastomeric ring has a first ear that projects along the shaft adjacent the end opening and inserts the ring into the channel, which slides the hub over the shaft, wherein the ear is dimensioned so that upon expansion the ear does not contact the surface of the end opening.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view of a lower end of a shaft with an impeller hub supported thereon, according to one exemplary embodiment of the present invention.

FIG. 2 is a cross-sectional view showing a layout of parts in their original uninstalled configuration, superimposed on each other, corresponding to the apparatus shown in FIG. 1.

FIG. 3 is a cross-sectional view of a hub according to the illustrated embodiment.

FIG. 4 is a cross-sectional view of a elastomeric ring according to a preferred embodiment being shown in a relaxed uninstalled configuration.

FIG. 5 is a cross-sectional view similar to FIG. 2, but shown in an installed condition where the elastomeric rings are expanded.

FIG. 6 is a cross-sectional view taken through reference line 6-6 in FIG. 5.

FIG. 7 is a perspective view of an impeller installed on a shaft according to the illustrated embodiment.

### DETAILED DESCRIPTION

Some embodiments of the invention provide improved impeller hub assemblies and methods which can reduce the number of component parts involved, be easy to install, and avoid the need for key ways and/or set screws. Preferred embodiments, by way of example, will now be described with reference to the drawing figures, in which like reference numerals refer to like parts throughout.

In general, some embodiments of the present invention provide for the frictional mounting of an impeller hub on to an elongated axial cylindrical shaft. The principles of the invention can be applied with regard to any size of hub and shaft geometry. Further, the principles of the invention can be applied to any suitable mixing, aerating, agitating or other application that involves rotating impellers via a shaft. One example in which some embodiments of the invention are suited is in the context of laboratory pilot program mixers. In some cases, some examples of mixers may be used in pharmaceutical or food applications. In these, and some other applications, cleanliness can be an important factor in the system. Some of these systems utilize clean-in-place (CIP) technology wherein the impeller and hub connection is cleaned by flushing with a cleaning solution at certain times. In these situations, it may be desirable to avoid allowing either the material being mixed, or the cleaning solution, from becoming too deeply entrained in small gaps, scratches or crevices where germ particulates may accumulate. However, even without regard to the cleaning circumstances, some embodiments of the invention provide for convenience and ease-of-use, as well as a reduced number of parts compared to some prior art systems.

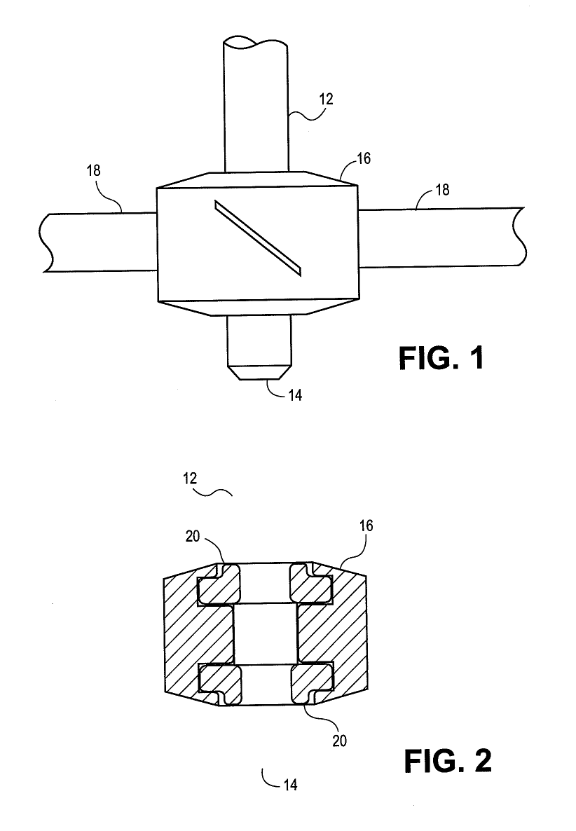

FIG. 1 is a front view of a lower end of a shaft with an impeller hub supported thereon, according to one exemplary embodiment of the present invention. FIG. 1 shows an impeller shaft 12 having a free lower end 14. Although not shown, a motor or other drive system, which may or may not involve a gear box, rotates the impeller shaft. A hub 16 is frictionally mounted on to the impeller shaft. The hub 16 therefore rotates with the shaft 12. The hub 16 supports any number of radially extending impellers 18 which are shown cut off and schematically only in FIGS. 1-5.

Due to the mounting arrangement of hub 16 which is discussed in more detail below, the hub 16 is frictionally held on to the shaft 12 such that it has an axial resistance force that tends to hold it in axial place in the shaft 12 against a predetermined degree of force, and also has a torque frictional fit against the shaft 12 so that it tends to rotate with the shaft 12 against a predetermined amount of force. The hub mounting is accomplished via a pair of elastomeric rings as discussed in more detail herein.

During setup or installation of the hub system, it will be appreciated that the hub 16 can simply be slid over the end 14 of the shaft and on to the shaft, and then manually positioned at the desirable axial location on the staff.

FIG. 2 depicts, in addition to the shafts 12 and 14 and hub 16, a pair of elastomeric rings 20. The elastomeric rings 20 are essentially the same as each other, except that they are axially symmetrical with respect to each other.

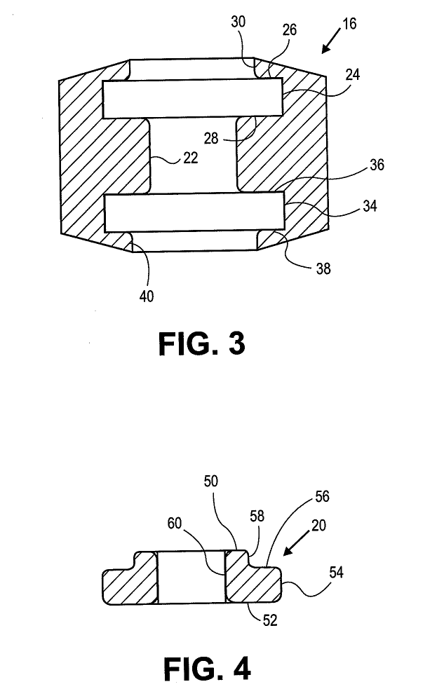

Referring now to FIGS. 3 and 4, further details of the hub 16 and elastomeric ring 20 are provided. Turning to the hub 16, it first will be appreciated that any number of impellers, and any shape of impellers, can be protruding radially outwardly from the hub 16. The depiction of cutoff impeller arms 18 is by way of schematic example only and any of suitable impeller shapes, sizes and geometries can be suitably used with embodiments of the present invention.

The hub 16 includes a central inner diameter portion 22, which is sized to be slightly larger than the outer diameter of the shaft 14. Upper and lower channels having a sidewall 24 are provided, as well as an upper face 26 and a lower face 28. An end opening 30 is provided having a diameter described in more detail below. The above description applies to the upper half of the hub 16. The lower half of the hub 16 also has a channel having an end wall 34, an upper wall 36, a lower wall 38, and an end opening 40. The parts in the lower half of the shaft are opposite symmetrical with the parts in the upper half of the shaft, and therefore further discussion will be made simply with respect to the upper half of the shaft.

FIG. 4 depicts an elastomeric ring 20 in a relaxed condition. The elastomeric ring has a top surface 50, a bottom surface 52, an outer radial surface 54, an upward facing surface 56, and an outer facing surface 58. The ring also includes an inner circumference 60. It will be appreciated that the surfaces 50 and 58 together form essentially an “ear,” which may be thought to project out of a main body formed by surfaces 56, 54, 52 and 60.

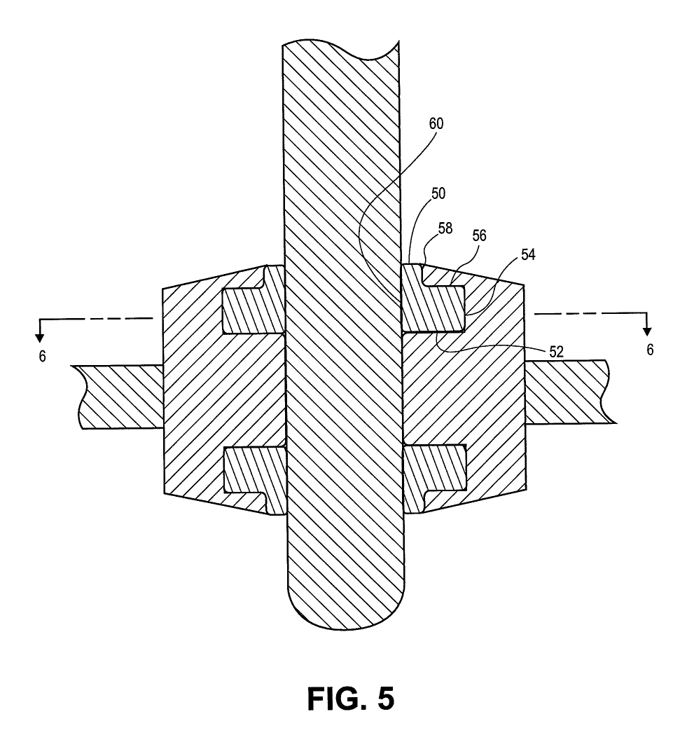

In order to install the hub 16 on the shaft 12, an upper and a lower elastomeric ring 20 is inserted into the upper and lower channels within the hub 16. FIG. 5 depicts an installed condition where the hub 16 with the elastomeric rings 20 has been slid on to a shaft 12. It will be appreciated that the inner circumference 60 of the elastomeric rings 20 becomes expanded and therefore has a compression friction fit against the outer surface of the shaft 12. The ear defined by edges 50 and 58 will also be compressed outward somewhat. However, the geometry of the ear 50, 58 is selected such that even during radial expansion due to installation, the surface 58 does not come into contact with the surface 30. The space between the surface 58 and the surface 30 can be dimensioned large enough so that cleaning fluid will be able to enter it during cleaning to such a degree that cleaning can occur in this area. Further, this space is large enough that germs or particulates do not tend to become trapped there, or if they do, they can be rinsed away via the cleaning solution. The friction fit between the surface 60 of the elastomeric ring 20 and the outer circumference of the shaft 12 has enough compression such that it can resist the torque between the two parts that occur during normal mixing processes. Further, this compression fit prevents any material, contaminates, or mixing fluid from entering this sealing region.

The surface 56 of the sealing ring 20 also fits snugly against the surface 26 of the hub 16. This provides some degree of seal and rotational resistance, and also provides a seal such that neither the material being mixed, nor cleaning fluid, is able to enter this region.

The surface 54 is also radially expanded such that it fits snugly against the surface 24 of the hub 16. This frictional contact does not need to provide torque resistance, but due to the added surface area can provide some additional torque resistance. Further, this region does not need to provide sealing, since the surface 56 has already provided a seal. However, due to the frictional fit further sealing may occur there. Finally, the surface 52 may be spaced away from the surface 28 of the hub 16. No sealing needs to occur in this region because it is already sealed off by the other surfaces described above. Moreover, the provision of a space between surfaces 52 and 28 can provide for some degree of design flexibility and accommodation of variations of compression in the elastomer. However, in other embodiments, the surface 52 in the installed state may contact with or be compressed against the surface 28 of the hub 16.

The interaction of the lower sealing ring with the lower channel in the hub is the same as described with respect to the upper half, but is symmetrically opposite.

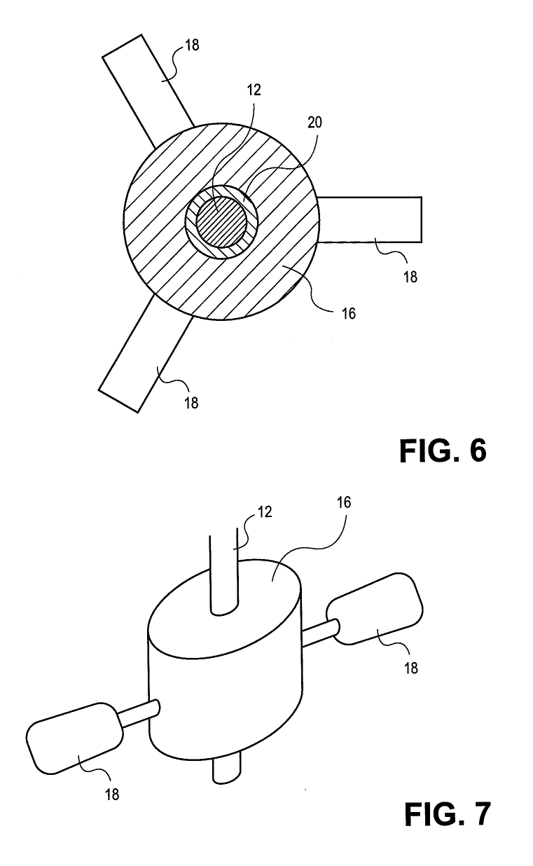

FIG. 6 is a cross-sectional view taken through line 6-6 in FIG. 5. FIG. 7 is a perspective view of the arrangement of FIG. 6. Both of these views are provided to illustrate the concept of an impeller provided radially extending outward from the hub. The selection of impeller geometry in this example is by way of example only, and in fact any number of radially extending impellers, having any shapes, can be used with this hub arrangement. Moreover, the impellers may simply extend directly radially off the hub, or may be placed on radially extending arms that extend away from the hub. Nothing in this application is intended to limit the impeller hub geometry or placement.

In certain embodiments, the shaft and hub may be made of metal, and in some examples may be of a high alloy such as 316 L steel, or any duplex steel. The elastomeric ring may be made of any suitable compressible material, but in some examples may be EPDM, or various types of fluoro elastomers. Depending on the compressibility of the elastomer, the relative geometry of the elastomer and the channels in the hub are designed such that a sufficient frictional contact, normal forces to achieve axial and torque resistance that will occur in normal operation are obtained. Thus, the system can be designed to accomplish a wide range of applications including different torques and sizes. By way of example only, one example for the embodiment of the invention would be a laboratory type pilot mixer having a half-inch diameter shaft. However, other sizes are implemented by adjusting the relative sizes and proportions of the ring and the hub.

It will be appreciated that a benefit of some embodiments of the invention is that the hub can be slid manually continuously along a part or all of the length of the shaft. This provides a continuous adjustment, as opposed to an incremental step type adjustment, of the axial position of the impellers. This can provide a single system where an axial position can be adjusted depending on the application or the type of impeller involved. Also, it permits for change out of different hubs so that different impellers can be used within a single overall mixing system.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An impeller mounting apparatus comprising:
an elongated cylindrical shaft;
a hub having a central aperture therethrough larger than the outer diameter of the shaft;
at least one first channel disposed on an inner circumference of the hub, having an end opening with a first diameter larger than the shaft; and
at least one first elastomeric ring having a central circumference less than the outer circumference of the shaft, and adapted to fit over the shaft and inside the channel, thereby becoming outwardly expanded into the channel, the elastomeric ring further having a first ear that projects along the shaft adjacent the end opening, wherein the first ear is dimensioned so that upon expansion the ear does not completely fill the end opening.

2. The apparatus of claim 1, further comprising a second channel disposed on an inner circumference of the hub, having an end opening with a first diameter larger than the shaft, and a second elastomeric ring having a central circumference less than the outer circumference of the shaft, and adapted to fit over the shaft and inside the second channel, thereby becoming outwardly expanded into the second channel, the elastomeric ring further having a second ear that projects along the shaft adjacent the end opening, wherein the second ear is dimensioned so that upon expansion the ear does not completely fill the end opening

3. The apparatus of claim 2, wherein the first and second elastomeric rings are axially opposite and symmetrical to each other, and wherein the first and second channels are axially symmetrically opposite to each other.

4. The apparatus of claim 1, wherein the elastomeric ring is made of a fluoro-elastomer polymer.

5. The apparatus of claim 1, wherein the elastomeric ring is made of EPDM.

6. The apparatus of claim 1, wherein the shaft and the hub are formed of stainless steel.

7. The apparatus of claim 1, wherein when the first elastomeric ring is installed inside the first channel, the hub can be slid axially along the shaft, while having a frictional resistance to torque and axial movement between the hub and the shaft.

8. The apparatus of claim 1, wherein the hub, when having the elastomeric ring installed therein, and with the hub installed on the shaft, is axially adjustable along the length of the shaft.

9. An impeller mounting apparatus comprising:
an elongated cylindrical shaft;
impeller mounting means having a central aperture therethrough larger than the outer diameter of the shaft;
at least one first channel disposed on an inner circumference of the impeller mounting means, having an end opening with a first diameter larger than the shaft; and
at least one first elastomeric ring having a central circumference less than the outer circumference of the shaft, and adapted to fit over the shaft and inside the channel, thereby becoming outwardly expanded into the channel, the elastomeric ring further having a first ear that projects along the shaft adjacent the end opening, wherein the first ear is dimensioned so that upon expansion the ear does not completely fill the end opening, wherein the first ear is dimensioned so that upon expansion the ear does not completely fill the end opening.

10. The apparatus of claim 9, further comprising a second channel disposed on an inner circumference of the impeller mounting means, having an end opening with a first diameter larger than the shaft, and a second elastomeric ring having a central circumference less than the outer circumference of the shaft, and adapted to fit over the shaft and inside the second channel, thereby becoming outwardly expanded into the second channel, the second elastomeric ring further having a second ear that projects along the shaft adjacent the end opening, wherein the second ear is dimensioned so that upon expansion the ear does not completely fill the end opening.

11. The apparatus of claim 10, wherein the first and second elastomeric rings are axially opposite and symmetrical to each other, and wherein the first and second channels are axially symmetrically opposite to each other.

12. The apparatus of claim 9, wherein the elastomeric ring is made of a fluoro-elastomer polymer.

13. The apparatus of claim 9, wherein the elastomeric ring is made of EPDM.

14. The apparatus of claim 9, wherein the shaft and the hub are formed of stainless steel.

15. The apparatus of claim 9, wherein when the first elastomeric ring is installed inside the first channel, the hub can be slid axially along the shaft, while having a frictional resistance to torque and axial movement between the hub and the shaft.

16. The apparatus of claim 9, wherein the hub, when having the elastomeric ring installed therein, and with the hub installed on the shaft, is axially adjustable along the length of the shaft.

17. A method for mounting an impeller into an elongated cylindrical shaft comprising:
providing a hub having a central aperture therethrough larger than the outer diameter of the shaft and at least one first channel disposed on an inner circumference of the hub, having an end opening with a first diameter larger than the shaft;
providing at least one first elastomeric ring having a central circumference less than the outer circumference of the shaft, and adapted to fit over the shaft and inside the channel, thereby becoming outwardly expanded into the channel, the elastomeric ring further having a first ear that projects along the shaft adjacent the end opening,
inserting the ring into the channel; and
sliding the hub over the shaft, wherein the ear is dimensioned so that upon expansion the ear does not contact the surface of the end opening.

18. The method of claim 17, where the hub further comprises a second channel wherein at least one channel disposed on an inner circumference of the hub, having an end opening with a first diameter larger than the shaft, and a second elastomeric ring having a central circumference less than the outer circumference of the shaft, and adapted to fit over the shaft and inside the second channel, thereby becoming outwardly expanded into the second channel, the second elastomeric ring further having a second ear that projects along the shaft adjacent the end opening.

19. The method of claim 18, wherein the first and second elastomeric rings are axially opposite and symmetrical to each other, and wherein the first and second channels are axially symmetrically opposite to each other.

20. The method of claim 17, wherein the elastomeric ring is the fluoro elastomer polymer.

21. The method of claim 17, wherein the elastomeric ring is made of EPDM.

22. The method of claim 17, wherein the shaft and the hub are formed of stainless steel.

23. The method of claim 17, wherein when the elastomeric ring is installed inside the channel, the hub can be slid axially along the shaft, while having a frictional resistance to torque and axial movement between the hub and the shaft.

24. The method of claim 17, wherein the hub, when having the elastomeric ring installed therein, and with the hub installed on the shaft, is axially adjustable along the length of the shaft.
